(19) United States
(12) Patent Application Publication
(10) Pub. No.: US 2026/0310198 A1
(43) Pub. Date: Oct. 8, 2026

(54) METHOD FOR CONTROLLING POOL ROBOT TO OPERATE, ELECTRONIC DEVICE, AND STORAGE MEDIUM

(71) Applicant: XINGMAI INNOVATION TECHNOLOGY (SUZHOU) CO., LTD., Suzhou (CN)

(72) Inventor: Shengle WANG, Suzhou (CN)

(73) Assignee: XINGMAI INNOVATION TECHNOLOGY (SUZHOU) CO., LTD., Suzhou (CN)

(21) Appl. No.: 19/578,800

(22) Filed: Mar. 25, 2026

Related U.S. Application Data
(63) Continuation of application No. PCT/CN2023/136536, filed on Dec. 5, 2023.

(30) Foreign Application Priority Data
Sep. 27, 2023 (CN) 2023112654975

(51) Int. Cl. G05D 1/229; E04H 4/16; G05D 1/223; G05D 1/648; G05D 105/10; G05D 107/00

(52) U.S. Cl. CPC G05D 1/2295; E04H 4/1654; G05D 1/2232; G05D 1/6484; G05D 2105/10; G05D 2107/29

(57) ABSTRACT

This application provides a method for controlling a pool robot to operate, an electronic device, and a storage medium. The method is applied to a client and includes: determining a no-go region on a first map in response to an operation triggered for the first map of a target water region (S202), where the client is configured to perform information interaction with the pool robot, and the no-go region includes a region in the target water region, where the pool robot is prohibited from performing a target operation in the region; and transmitting region information of the no-go region to the pool robot to instruct the pool robot to generate a target operation path based on the region information and perform the target operation in another water region along the target operation path (S204).

### CROSS-REFERENCE TO RELATED APPLICATIONS

This application is a continuation of International Patent Application No. PCT/CN2023/136536, filed with the World Intellectual Property Organization on Dec. 05, 2023, which claims priority to: Chinese Patent Application No. 202311265497.5, filed with the China National Intellectual Property Administration on Sep. 27, 2023 and entitled "METHOD FOR CONTROLLING POOL ROBOT TO OPERATE, ELECTRONIC DEVICE, AND STORAGE MEDIUM", which is incorporated herein by reference in its entirety.

### TECHNICAL FIELD

Embodiments of this application relate to the robot field, and specifically, to a method for controlling a pool robot to operate, an electronic device, and a storage medium.

### BACKGROUND

A relevant pool robot can only plan a path in a water region based on a preset map and perform an operation along a planned path. However, the pool robot may be trapped in a specific region or only perform an operation in a specific region during operation, leading to a reduction in operation efficiency of the pool robot.

### SUMMARY

Embodiments of this application provide a method for controlling a pool robot to operate, an electronic device, and a storage medium, to at least resolve a problem in a related technology that a pool robot may be trapped in a specific region or only perform an operation in a specific region during operation, leading to a reduction in operation efficiency.

According to an embodiment of this application, a method for controlling a pool robot to operate is provided. The method is applied to a client and includes: determining a no-go region on a first map in response to an operation triggered for the first map of a target water region, where the client is configured to perform information interaction with the pool robot, and the no-go region includes a region in the target water region, where the pool robot is prohibited from performing a target operation in the region; and transmitting region information of the no-go region to the pool robot to instruct the pool robot to generate a target operation path based on the region information and perform the target operation in another water region along the target operation path, where the another water region is a water region in the target water region other than the no-go region.

According to another embodiment of this application, a method for controlling a pool robot to operate is provided. The method is applied to the pool robot and includes: receiving region information of a no-go region transmitted by a client, where the client determines the no-go region on a first map in response to an operation triggered for the first map of a target water region, where the client is configured to perform information interaction with the pool robot, and the no-go region includes a region in the target water region, where the pool robot is prohibited from performing a target operation in the region; generating a target operation path based on the region information; and performing the target operation in another water region along the target operation path, where the another water region is a water region in the target water region other than the no-go region.

According to still another embodiment of this application, a computer-readable storage medium is further provided. The computer-readable storage medium stores a computer program. When the computer program is run, steps in any one of the method embodiments are performed.

According to still another embodiment of this application, an electronic device is further provided. The electronic device includes a memory and a processor. The memory stores a computer program. The processor is configured to: when executing the computer program, perform steps in any one of the method embodiments.

According to this application, after determining the no-go region on the first map, the client transmits the region information of the no-go region to the pool robot, so that the pool robot can generate the target operation path based on the region information and perform the target operation in another water region along the target operation path. The pool robot does not perform the target operation in the no-go region to prevent the pool robot from being trapped in the no-go region, or the pool robot only performs the target operation in the another water region, so that a scope of performing the target operation is reduced, and precision of performing the target operation is improved.

### BRIEF DESCRIPTION OF THE DRAWINGS

FIG. 1 is a block diagram of a hardware structure of a mobile terminal for performing a method for controlling a pool robot to operate according to an embodiment of this application;

FIG. 2 is a flowchart 1 of a method for controlling a pool robot to operate according to an embodiment of this application;

FIG. 3 is a schematic diagram of a no-go region according to an embodiment of this application;

FIG. 4 is a flowchart 2 of a method for controlling a pool robot to operate according to an embodiment of this application;

FIG. 5 is a schematic diagram of a virtual wall according to an embodiment of this application;

FIG. 6 is a block diagram 1 of a structure of an apparatus for controlling a pool robot to operate according to an embodiment of this application; and

FIG. 7 is a block diagram 2 of a structure of an apparatus for controlling a pool robot to operate according to an embodiment of this application.

### DETAILED DESCRIPTION OF THE EMBODIMENTS

Embodiments of this application are described in detail in the following with reference to the accompanying drawings.

It should be noted that in this specification, claims, and the accompanying drawings of this application, the terms "first", "second", and the like are intended to distinguish between similar objects but do not necessarily indicate a specific order or sequence.

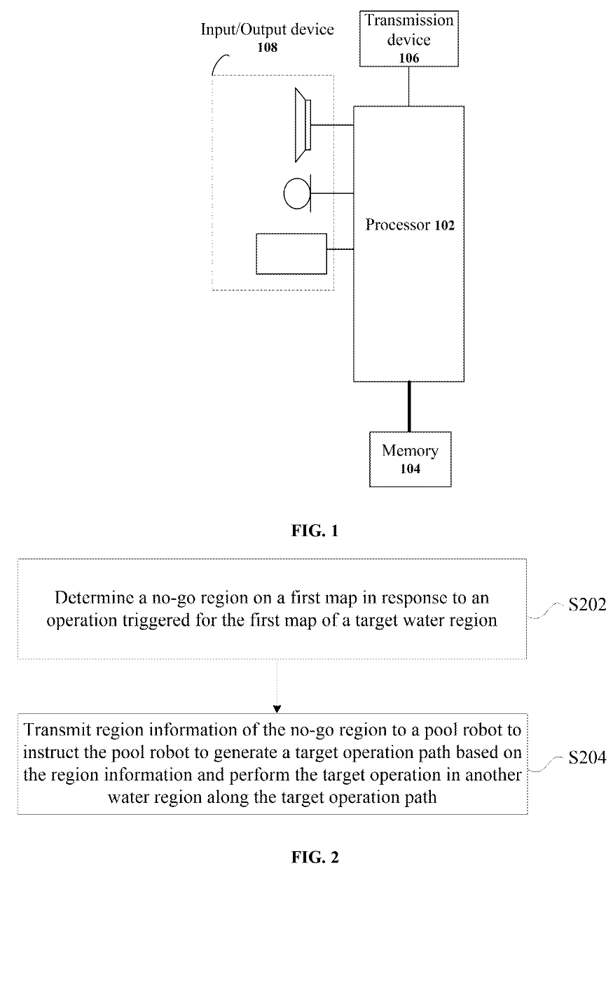

The method provided in embodiments of this application may be performed by a mobile terminal, a computer terminal, or a similar computing apparatus. An example in which the method is performed by the mobile terminal is used. FIG. 1 is a block diagram of a hardware structure of a mobile terminal for performing a method for controlling a pool robot to operate according to an embodiment of this application. As shown in FIG. 1, the mobile terminal may include one or more (only one processor is shown in FIG. 1) processors 102 (the processor 102 may include, but is not limited to, a processing apparatus such as a microprocessor unit MPU or a field-programmable gate array FPGA) and a memory 104 configured to store data. The mobile terminal may further include a transmission device 106 with a communication function and an input/output device 108. A person skilled in the art may understand that the structure shown in FIG. 1 is only an example and does not constitute any limitation on the structure of the mobile terminal. For example, the mobile terminal may alternatively include more or fewer components than those shown in FIG. 1 or have a configuration different from that shown in FIG. 1.

The memory 104 may be configured to store a computer program, for example, a software program of application software and modules, for example, a computer program corresponding to the method for controlling a pool robot to operate in embodiments of this application. The processor 102 executes the computer program stored in the memory 104 to execute various functional applications and data processing, that is, to implement the above method. The memory 104 may include a high-speed random access memory or a non-volatile memory, for example, one or more magnetic storage apparatuses, a flash memory, or another non-volatile solid-state memory. In some examples, the memory 104 may further include memories that are remotely disposed relative to the processor 102, and these remote memories may be connected to the mobile terminal through a network. Examples of the foregoing network include, but are not limited to, the Internet, an intranet, a local area network, a mobile communication network, and a combination thereof.

The transmission device 106 is configured to receive or send data through a network. Specific examples of the network may include a wireless network provided by a communication provider of the mobile terminal. In one example, the transmission device 106 includes a network interface controller (Network Interface Controller, NIC) that may be connected to other network devices through a base station to communicate with the Internet. In one example, the transmission device 106 may be a radio frequency (Radio Frequency, RF) module configured to communicate with the Internet in a wireless manner.

An embodiment provides a method for controlling a pool robot to operate. FIG. 2 is a flowchart 1 of a method for controlling a pool robot to operate according to an embodiment of this application. As shown in FIG. 2, the method may include the following steps.

Step S202: Determine a no-go region on a first map in response to an operation triggered for the first map of a target water region, where a client is configured to perform information interaction with the pool robot, and the no-go region includes a region in the target water region, where the pool robot is prohibited from performing a target operation in the region.

Step S204: Transmit region information of the no-go region to the pool robot to instruct the pool robot to generate a target operation path based on the region information and perform the target operation in another water region along the target operation path, where the another water region is a water region in the target water region other than the no-go region.

The above steps may be performed by the client. The client is disposed in a terminal, and the terminal is provided with a specific processor.

According to the above steps, after determining the no-go region on the first map, the client transmits the region information of the no-go region to the pool robot, so that the pool robot can generate the target operation path based on the region information and perform the target operation in another water region along the target operation path. The pool robot does not perform the target operation in the no-go region to prevent the pool robot from being trapped in the no-go region, or the pool robot only performs the target operation in the another water region, so that a scope of performing the target operation is reduced, and precision of performing the target operation is improved. In this way, a problem in a related technology that a pool robot may be trapped in a specific region or only perform an operation in a specific region during operation, leading to a reduction in operation efficiency can be resolved. This effectively improves the operation efficiency.

The first map is a map of the target water region and may be a two-dimensional map or a three-dimensional map. The first map may be generated when the pool robot operates along an edge of the target water region.

Optionally, the pool robot may include, but is not limited to, a cleaning robot for cleaning the target water region and a disinfection robot for disinfecting water in the target water region.

Optionally, the target water region includes, but is not limited to, an enclosed water region, for example, a swimming pool, a fish pond, a pool, an aquarium, and a bathtub, and a region including the no-go region includes, but is not limited to, a special region in the target water region, for example, a region in a swimming pool having a step and/or a ladder and a region in a fish pond provided with an oxygen device.

Optionally, the target operation includes, but is not limited to, a cleaning operation, a disinfection operation, a retrieving operation, and the like. For example, the cleaning robot performs a cleaning operation in the swimming pool, the disinfection robot performs a disinfection operation in the swimming pool, or the cleaning robot simultaneously cleans debris and spreads a disinfectant in the swimming pool to simultaneously clean and disinfect the swimming pool.

Optionally, the no-go region may be a region defined by a virtual wall disposed in the target water region, and the virtual wall is a barrier disposed in the target water region. For example, when the target water region is a swimming pool, and the target operation is a cleaning operation, a virtual wall is disposed in a region in which a step and/or a ladder in the swimming pool are/is located, and a region between the virtual wall and a physical wall corresponding to the step and/or the ladder in the target water region is determined as the no-go region, so that the pool robot cannot move onto the step and/or the ladder to perform a cleaning operation. In addition, the pool robot does not perform a cleaning operation on the virtual wall but only performs a cleaning operation on the physical wall and another water region. The no-go region may be further a target region in the target water region. For example, when the target water region is a swimming pool, and the target operation is a cleaning operation, a specified water region between a water surface and a bottom of the pool is determined as the no-go region in which the cleaning operation is prohibited. Alternatively, a region in which the cleaning robot is easily trapped in the swimming pool is determined as the target region in which the cleaning operation is prohibited.

Optionally, the region information of the no-go region includes, but is not limited to, specific coordinates of the no-go region displayed on the first map and an identifier of the no-go region displayed on the first map. The identifier includes a name and/or an icon of the no-go region, for example, an icon of the step and/or the ladder or a name of the step and/or the ladder in the swimming pool displayed on the first map.

Optionally, the no-go region may be determined on the first map before the pool robot enters water and performs the target operation, or the no-go region may be determined on the first map in real time in a process in which the pool robot performs the target operation in water.

Optionally, the client may be an application installed on the terminal, and there is an interaction relationship between the application and the pool robot. The pool robot may send information indicating that the target operation is performed in the target water region and motion information to the application for display. The application may also receive a control instruction of a user and transmit the control instruction to the pool robot to instruct the pool robot to perform the target operation in the target water region. For example, the application for controlling the pool robot to operate is installed on a mobile phone of the user, and the user may observe an operation condition of the pool robot in the target water region by using the application.

In some embodiments, the determining a no-go region on a first map in response to an operation triggered for the first map of a target water region includes one of the following: receiving an operation instruction and determining the no-go region on the first map in response to the operation instruction, where the region information is generated when the no-go region is determined based on the operation instruction; and determining the no-go region on the first map in response to a touchscreen operation performed on the first map, where the touchscreen operation includes an action performed on the first map to generate the no-go region.

Optionally, the operation triggered for the first map of the target water region includes an operation triggered based on the operation instruction and an action triggered by the touchscreen operation. The operation instruction includes position information of a region that needs to be set as the no-go region. For example, when the first map is a map of the swimming pool, the user inputs a position of the step and/or the ladder on the first map into the client, and the client determines a region in which the step and/or the ladder are/is located as the no-go region based on the position of the step and/or the ladder and sends, to the pool robot, generated coordinates of the step and/or the ladder. Alternatively, the user inputs a name of the step and/or the ladder displayed on the first map into the client, and the client determines the region in which the step and/or the ladder are/is located as the no-go region based on the name of the step and/or the ladder and sends, to the pool robot, generated coordinates of the region in which the step and/or the ladder are/is located and the name of the step and/or the ladder.

The touchscreen operation is an action directly performed by the user on the first map displayed on the client, and after identifying the action of the user, the client determines a position on the first map at which the action is performed as the no-go region. For example, the action of the user is a sliding operation performed by the user at a position of the step and/or the ladder on the first map through the client. When a trajectory corresponding to the sliding operation is a periphery of the step and/or the ladder, a position on the first map at which the action is performed may be determined as the position of the step and/or the ladder, so that the position of the step and/or the ladder is determined as the no-go region, and generated coordinates of the region in which the step and/or the ladder are/is located are sent to the pool robot. Optionally, when the user performs the touchscreen operation, the client may display a corresponding operation pattern on the first map based on the touchscreen operation, for example, a line, so that the user can know in time whether the touchscreen operation meets a user requirement. It should be noted that the region information of the no-go region is information (for example, coordinate information) identified by the client from the first map after the no-go region is determined. In this embodiment, the no-go region is determined on the first map based on the operation instruction or the touchscreen operation to improve accuracy and flexibility of determining the no-go region.

In some embodiments, the transmitting region information of the no-go region to the pool robot to instruct the pool robot to generate a target operation path based on the region information includes one of the following: generating a second map based on the region information and transmitting the second map to the pool robot to instruct the pool robot to generate the target operation path based on the second map; and transmitting the region information to the pool robot to instruct the pool robot to generate the second map based on the region information and generate the target operation path based on the second map.

The client may generate the second map based on the region information of the no-go region and directly transmit the second map to the pool robot or directly transmit the region information of the no-go region to the pool robot, enabling the pool robot to generate the second map. This improves generation flexibility of the second map.

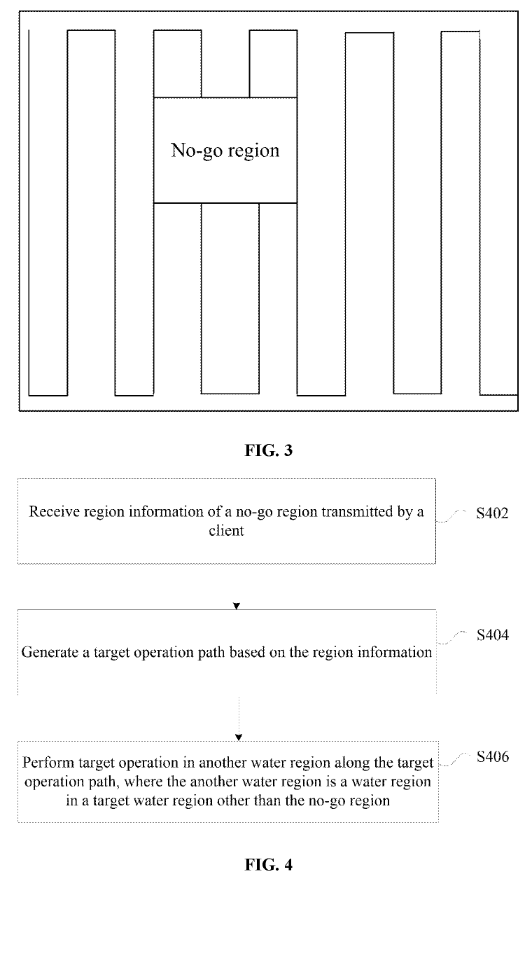

After the pool robot generates the second map or obtains the second map from the client, the pool robot generates the target operation path based on the second map. The target operation path is a path along which the pool robot needs to perform the target operation in the second map, for example, a bow-shaped path (the bow-shaped path means that two adjacent paths are parallel to each other, and the pool robot moves along the two adjacent paths in two opposite forward directions) shown in FIG. 3, a spider web-shaped path, or a Y-shaped path. Optionally, the target operation path may be generated based on the second map and a preset path generation algorithm.

Optionally, the generating a second map based on the region information may be shielding the no-go region on the first map based on the region information or marking the no-go region on the first map as a special symbol. The shielding the no-go region on the first map based on the region information includes, but is not limited to, deleting coordinates of the no-go region on the first map, setting an attribute of the coordinates of the no-go region to be not displayed, or directly deleting the no-go region from the first map. The no-go region is marked as a special symbol on the first map, and the special symbol may be a block shown in FIG. 3 or other symbols. The no-go region is set on the first map in a plurality of manners. This improves flexibility and accuracy of setting the no-go region.

Optionally, the first map may be displayed as a two-dimensional map or a three-dimensional map on the client. When the first map is a two-dimensional map, the second map may be directly generated on the two-dimensional map based on the region information. The second map is also a two-dimensional map and is sent to the pool robot. The pool robot generates the target operation path on the two-dimensional second map. Alternatively, two-dimensional coordinates of the no-go region are directly sent to the pool robot, and the pool robot generates the two-dimensional second map based on the two-dimensional coordinates and generates the target operation path on the two-dimensional second map.

Optionally, the generating a second map based on the region information of the no-go region includes: when the first map is a three-dimensional map, converting the first map into a first two-dimensional map; converting three-dimensional coordinates of the no-go region on the first map into two-dimensional coordinates to obtain the two-dimensional coordinates of the no-go region, where the region information includes the three-dimensional coordinates of the no-go region; shielding the two-dimensional coordinates of the no-go region on the first two-dimensional map or marking the two-dimensional coordinates of the no-go region on the first two-dimensional map to obtain a second two-dimensional map; and converting the second two-dimensional map into a three-dimensional map to obtain the second map. For example, if the first map is a three-dimensional map of the swimming pool, and the user needs to set the step and/or the ladder in the swimming pool as the no-go region, the client converts the three-dimensional map including six planes into two-dimensional maps, sets a position corresponding to the step and/or the ladder on the two-dimensional map as the no-go region, and after the no-go region is generated, re-converts the two-dimensional map into a three-dimensional map and re-sends the three-dimensional map to the pool robot. Alternatively, the position corresponding to the step and/or the ladder is directly sent to the pool robot, and the pool robot generates the three-dimensional second map based on the position of the step and/or the ladder and generates the target operation path on the three-dimensional second map.

In this embodiment, the client generates the second map based on a type of the first map. This reduces map processing complexity.

In some embodiments, the determining a no-go region on a first map in response to an operation triggered for the first map of a target water region includes one of the following: when the operation is determining a virtual wall on the first map, determining a region defined by the virtual wall as the no-go region; and when the operation is determining a target region on the first map, determining the target region as the no-go region.

Optionally, the virtual wall and the target region may be set based on the operation instruction or the touchscreen operation. The operation instruction and the touchscreen operation are described in the above embodiment. Details are not described herein again. In addition, the virtual wall and the target region may be set at any position in the target water region, and a plurality of virtual walls and a plurality of target regions may be set. For example, four virtual walls may be set around a lifesaving equipment in the swimming pool to surround the lifesaving equipment, so that the cleaning robot does not enter a region in which the lifesaving equipment is located and perform a cleaning operation. Alternatively, if the lifesaving equipment is located in a corner, a single virtual wall may be set outside the lifesaving equipment, so that a region (for example, a triangular region) defined by the virtual wall and two walls adjacent to the lifesaving equipment is determined as the no-go region.

Alternatively, regions in which a plurality of steps and/or ladders in the swimming pool are located are all set as target regions, so that the cleaning robot does not move to the region in which the step and/or the ladder are/is located and perform cleaning. In this embodiment, a plurality of types of no-go regions are set on the first map, so that the pool robot can adapt to a plurality of different application scenarios. This improves accuracy of setting the no-go region.

Optionally, when the no-go region is the region defined by the virtual wall, the pool robot does not need to perform the target operation on the virtual wall, but performs the target operation in another water region other than the virtual wall. For example, the cleaning robot in the swimming pool bypasses the virtual wall and performs the cleaning operation on the physical wall, or the cleaning robot performs the cleaning operation along an edge of the virtual wall or moves along an edge of the virtual wall to the physical wall and then performs the cleaning operation on the physical wall.

Optionally, when the no-go region is determined in real time in a process in which the pool robot performs the target operation in water, and the no-go region is the region defined by the virtual wall, a region away from the pool robot may be determined as the no-go region. For example, a single virtual wall divides the target water region into a first section and a second section, and if the pool robot is currently located in the first section, the second section is determined as the no-go region.

In some embodiments, the method further includes: when it is determined that the pool robot is abnormal in a process in which the pool robot performs the target operation in the target water region, determining an abnormal water region in which the pool robot is abnormal; and setting the abnormal water region as the no-go region on the first map.

Optionally, an abnormality occurred in the process in which the pool robot performs the target operation in the target water region includes, but is not limited to, the pool robot is trapped in a corner in the target water region; the pool robot rolls over in a region in which a step and/or a ladder in the target water region are/is located; and the pool robot is entangled with a device disposed in the target water region. In this embodiment, the abnormal water region may be determined as the no-go region in real time in a process in which the pool robot operates in the target water region. For example, when the cleaning robot performs the cleaning operation in the swimming pool, the cleaning robot is trapped in the corner in the swimming pool and then transmits coordinates of the corner to the client, and the client sets the corner as the no-go region. In this embodiment, the no-go region is set in real time, so that the pool robot can adapt to different application scenarios. This can better improve target operation execution efficiency of the pool robot.

Optionally, the no-go region may be preset based on a user requirement before the pool robot operates to the target water region and performs the target operation. For example, the user thinks that it is difficult to clean the step and/or the ladder in the swimming pool, and the region in which the step and/or the ladder are/is located needs to be set as a region in which cleaning is prohibited from being performed. In this case, before the pool robot performs cleaning in the swimming pool, the region in which the step and/or the ladder are/is located is set as the no-go region through the client. In this embodiment, the no-go region is preset to improve target operation execution efficiency of the pool robot.

An embodiment provides a method for controlling a pool robot to operate. FIG. 4 is a flowchart 2 of a method for controlling a pool robot to operate according to an embodiment of this application. As shown in FIG. 4, the method may include the following steps.

Step S402: Receive region information of a no-go region transmitted by a client, where the client determines the no-go region on a first map in response to an operation triggered for the first map of a target water region, where the client is configured to perform information interaction with the pool robot, and the no-go region includes a region in the target water region, where the pool robot is prohibited from performing a target operation in the region.

Step S404: Generate a target operation path based on the region information.

Step S406: Perform the target operation in another water region along the target operation path, where the another water region is a water region in the target water region other than the no-go region.

The above steps may be performed by the pool robot, and the pool robot is provided with a specific processor.

According to the above steps, the pool robot receives the region information of the no-go region transmitted by the client, so that the pool robot can generate the target operation path based on the region information and perform the target operation in another water region along the target operation path. The pool robot does not perform the target operation in the no-go region to prevent the pool robot from being trapped in the no-go region, or the pool robot only performs the target operation in the another water region, so that a scope of performing the target operation is reduced, and precision of performing the target operation is improved. In this way, a problem in a related technology that a pool robot may be trapped in a specific region or only perform an operation in a specific region during operation, leading to a reduction in operation efficiency can be resolved. This effectively improves the operation efficiency.

The first map is a map of the target water region and may be a two-dimensional map or a three-dimensional map. The first map may be generated when the pool robot operates along an edge of the target water region.

Optionally, the pool robot may include, but is not limited to, a cleaning robot for cleaning the target water region and a disinfection robot for disinfecting water in the target water region.

Optionally, the target water region includes, but is not limited to, an enclosed water region, for example, a swimming pool, a fish pond, a pool, an aquarium, and a bathtub, and a region including the no-go region includes, but is not limited to, a special region in the target water region, for example, a region in a swimming pool having a step and/or a ladder and a region in a fish pond provided with an oxygen device.

Optionally, the target operation includes, but is not limited to, a cleaning operation, a disinfection operation, a retrieving operation, and the like. For example, the cleaning robot performs a cleaning operation in the swimming pool, the disinfection robot performs a disinfection operation in the swimming pool, or the cleaning robot simultaneously cleans debris and spreads a disinfectant in the swimming pool to simultaneously clean and disinfect the swimming pool.

Optionally, the no-go region may be a region defined by a virtual wall disposed in the target water region, and the virtual wall is a barrier disposed in the target water region. For example, when the target water region is a swimming pool, and the target operation is a cleaning operation, a virtual wall is disposed in a region in which a step and/or a ladder in the swimming pool are/is located, and a region between the virtual wall and a physical wall corresponding to the step and/or the ladder in the target water region is determined as the no-go region, so that the pool robot cannot move onto the step and/or the ladder to perform a cleaning operation. In addition, the pool robot does not perform a cleaning operation on the virtual wall but only performs a cleaning operation on the physical wall and another water region. The no-go region may be further a target region in the target water region. For example, when the target water region is a swimming pool, and the target operation is a cleaning operation, a specified water region between a water surface and a bottom of the pool is determined as the no-go region in which the cleaning operation is prohibited. Alternatively, a region in which the cleaning robot is easily trapped in the swimming pool is determined as the target region in which the cleaning operation is prohibited.

Optionally, the region information of the no-go region includes, but is not limited to, specific coordinates of the no-go region displayed on the first map and an identifier of the no-go region displayed on the first map. The identifier includes a name and/or an icon of the no-go region, for example, an icon of the step and/or the ladder or a name of the step and/or the ladder in the swimming pool displayed on the first map.

Optionally, the no-go region may be determined on the first map before the pool robot enters water and performs the target operation, or the no-go region may be determined on the first map in real time in a process in which the pool robot performs the target operation in water.

Optionally, the client may be an application installed on the terminal, and there is an interaction relationship between the application and the pool robot. The pool robot may send information indicating that the target operation is performed in the target water region and motion information to the application for display. The application may also receive a control instruction of a user and transmit the control instruction to the pool robot to instruct the pool robot to perform the target operation in the target water region. For example, the application for controlling the pool robot to operate is installed on a mobile phone of the user, and the user may observe an operation condition and an operation path of the pool robot in the target water region by using the application.

In some embodiments, the generating a target operation path based on the region information includes: receiving a second map transmitted by the client, where the second map is generated by the client based on the region information of the no-go region; and generating the target operation path on the second map. Optionally, a manner in which the pool robot generates the target operation path on the second map is not limited. The target operation path may be an edge-following path, a bow-shaped path, a Y-shaped path, or the like. The pool robot receives the second map to directly generate the target operation path on the second map. This improves generation efficiency of the target operation path.

In some embodiments, the generating a target operation path based on the region information includes: receiving the region information of the no-go region transmitted by the client; generating a second map based on the region information; and generating the target operation path on the second map. In this embodiment, after receiving the region information, the pool robot autonomously generates the second map and generates the target operation path. This reduces processing pressure of the client.

The pool robot may directly receive the second map transmitted by the client or generate the second map based on the region information of the no-go region transmitted by the client. This improves generation flexibility of the second map.

After the pool robot generates the second map or obtains the second map from the client, the pool robot generates the target operation path based on the second map. The target operation path is a path along which the pool robot needs to perform the target operation in the second map, for example, a bow-shaped path shown in FIG. 3, a spider web-shaped path, or a Y-shaped path. Optionally, the target operation path may be generated based on the second map and a preset path generation algorithm.

In some embodiments, the performing the target operation in another water region along the target operation path includes one of the following: when the no-go region is a target region, and the pool robot is located in the target region, moving out of the target region and performing the target operation in the another water region along the target operation path; and when the no-go region is the target region, and the pool robot is located outside the target region, performing the target operation in the another water region along the target operation path. When the no-go region is determined in real time in a process in which the pool robot performs the target operation, and the no-go region is the target region, if the pool robot is located in the target region, the pool robot moves out of the target region and performs the target operation in the another water region along the target operation path, or if the pool robot is located outside the target region, the pool robot performs the target operation in the another water region along the target operation path. In this embodiment, when the pool robot is located in the target region, the pool robot moves out of the target region to prevent the pool robot from directly stopping in the no-go region. This improves effectiveness for setting the no-go region. When the pool robot is located outside the target region, the pool robot directly performs the target operation in the another water region along the newly planned target operation path. This improves operation execution efficiency.

Optionally, when the no-go region is the region defined by the virtual wall, the pool robot does not need to perform the target operation on the virtual wall, but performs the target operation in another water region other than the virtual wall. For example, the cleaning robot in the swimming pool bypasses the virtual wall and performs the cleaning operation on the physical wall, or the cleaning robot performs the cleaning operation along an edge of the virtual wall or moves along an edge of the virtual wall to the physical wall and then performs the cleaning operation on the physical wall.

The following specifically describes the present disclosure with reference to a specific embodiment.

An example of a cleaning robot for cleaning a swimming pool is used for description in this embodiment. In this embodiment, the user draws a virtual wall on the first map of the swimming pool through the client to determine the no-go region, and the cleaning robot generates the target operation path based on the second map generated based on the region information of the no-go region and performs a cleaning operation in another water region along the target operation path. As shown in FIG. 5, a three-dimensional virtual wall a is set between the bottom of the swimming pool and the water surface on the first map of the swimming pool through the client. A height of the virtual wall is a distance between the bottom of the swimming pool and the water surface. The virtual wall a divides the swimming pool into the no-go region and the another water region to form the second map. In FIG. 5, regions marked with dense lines on two sides represent physical walls of the another water region. After completing the cleaning operation on a left physical wall in FIG. 5 along the target operation path based on the second map, the cleaning robot may perform the cleaning operation on the bottom of the another water region or moves from the bottom of the another water region to a right physical wall to climb the wall and perform the cleaning operation, and does not perform the cleaning operation in the no-go region and on the virtual wall. This improves efficiency and effectiveness of performing the cleaning operation.

Based on the foregoing descriptions of the implementations, a person skilled in the art may clearly understand that the method in the above embodiments may be implemented by software in addition to a necessary universal hardware platform or by hardware only. In many cases, the former is a preferred implementation. Based on such understanding, the technical solutions of this application can be essentially or the part that contributes to the related technology can be embodied in a form of a software product. This computer software product is stored in a storage medium (for example, a ROM/RAM, a magnetic disk, or a compact disc), and includes several instructions for instructing a terminal device (which may be a mobile phone, a computer, a server, or a network device) to perform the method described in embodiments of this application.

An embodiment further provides an apparatus for controlling a pool robot to operate. The apparatus is configured to implement the above embodiments and optional implementations. Some that have been described are not described in detail again. The term "module" used below may be a combination of software and/or hardware that implements a preset function. Although the apparatus described in the following embodiment is preferably implemented in software, it may be conceived that the apparatus is implemented in hardware or a combination of software and hardware.

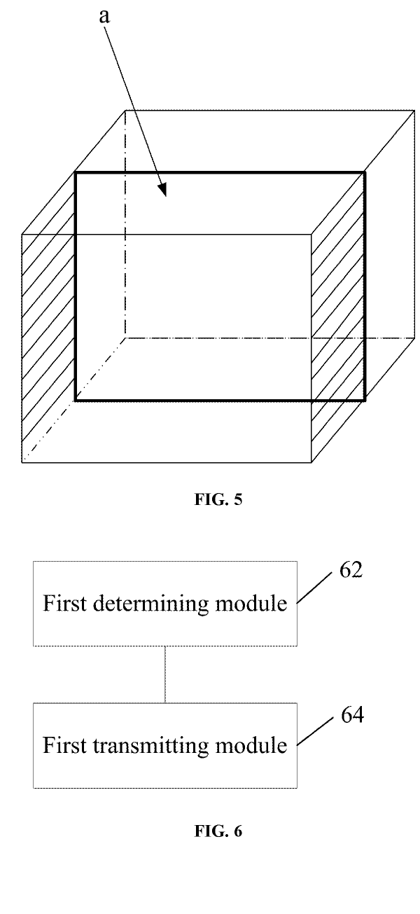

FIG. 6 is a block diagram 1 of a structure of an apparatus for controlling a pool robot to operate according to an embodiment of this application. As shown in FIG. 6, the apparatus includes: a first determining module 62 configured to determine a no-go region on a first map in response to an operation triggered for the first map of a target water region, where a client is configured to perform information interaction with the pool robot, and the no-go region includes a region in the target water region, where the pool robot is prohibited from performing a target operation in the region; and a first transmitting module 64 configured to transmit region information of the no-go region to the pool robot to instruct the pool robot to generate a target operation path based on the region information and perform the target operation in another water region along the target operation path, where the another water region is a water region in the target water region other than the no-go region.

In some embodiments, the first operation module includes one of the following: a first receiving unit configured to receive an operation instruction and determine the no-go region on the first map in response to the operation instruction, where the region information is generated when the no-go region is determined based on the operation instruction; and a first determining unit configured to determine the no-go region on the first map in response to a touchscreen operation performed on the first map, where the touchscreen operation includes an action performed on the first map to generate the no-go region.

In some embodiments, the first transmitting module includes one of the following: a first generation unit configured to generate a second map based on the region information and transmit the second map to the pool robot to instruct the pool robot to generate the target operation path based on the second map; and a first transmitting unit configured to transmit the region information to the pool robot to instruct the pool robot to generate the second map based on the region information and generate the target operation path based on the second map.

In some embodiments, the first generation unit includes: a first conversion sub-unit configured to when the first map is a three-dimensional map, convert the first map into a first two-dimensional map; a second conversion sub-unit configured to convert three-dimensional coordinates of the no-go region on the first map into two-dimensional coordinates to obtain the two-dimensional coordinates of the no-go region, where the region information includes the three-dimensional coordinates of the no-go region; a first shielding sub-unit configured to shield the two-dimensional coordinates of the no-go region on the first two-dimensional map or mark the two-dimensional coordinates of the no-go region on the first two-dimensional map to obtain a second two-dimensional map; and a first conversion sub-unit configured to convert the second two-dimensional map into a three-dimensional map to obtain the second map.

In some embodiments, the first determining module includes one of the following: a second determining unit configured to when the operation is determining a virtual wall on the first map, determine a region defined by the virtual wall as the no-go region; and a third determining unit configured to when the operation is determining a target region on the first map, determine the target region as the no-go region.

In some embodiments, the virtual wall and the target region are set based on the operation instruction or the touchscreen operation, and the virtual wall and the target region are allowed to be set at any position in the target water region. A plurality of virtual walls and a plurality of target regions are allowed to be set in the target water region.

In some embodiments, when the no-go region is determined in real time in a process in which the pool robot performs the target operation in water, and the no-go region is the region defined by the virtual wall, a region away from the pool robot is allowed to be determined as the no-go region.

In some embodiments, the apparatus further includes: a second determining module configured to when it is determined that the pool robot is abnormal in a process in which the pool robot performs the target operation in the target water region, determine an abnormal water region in which the pool robot is abnormal; and a first setting module configured to set the abnormal water region as the no-go region on the first map.

In some embodiments, an abnormality occurred in the process in which the pool robot performs the target operation in the target water region includes at least one of the following: the pool robot is trapped in a corner in the target water region; the pool robot rolls over in a region in which a step and/or a ladder in the target water region are/is located; or the pool robot is entangled with a device disposed in the target water region.

In some embodiments, the region information of the no-go region includes at least one of the following: coordinates of the no-go region displayed on the first map or an identifier of the no-go region displayed on the first map. The identifier includes a name and/or an icon of the no-go region.

In some embodiments, the no-go region is determined on the first map before the pool robot performs the target operation, or the no-go region is determined on the first map in real time in a process in which the pool robot performs the target operation in the target water region.

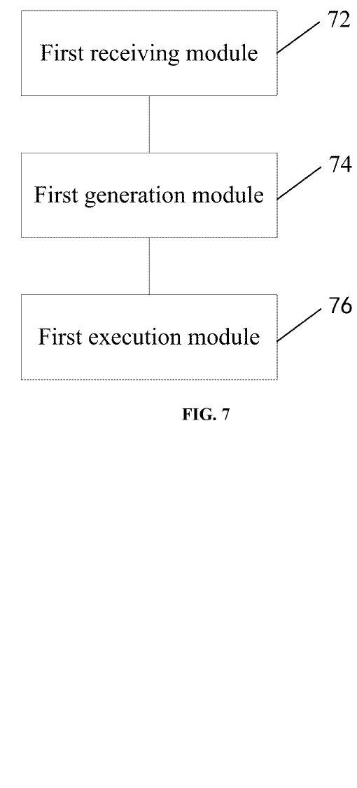

FIG. 7 is a block diagram 2 of a structure of an apparatus for controlling a pool robot to operate according to an embodiment of this application. As shown in FIG. 7, the apparatus includes: a first receiving module 72 configured to receive region information of a no-go region transmitted by a client, where the client determines the no-go region on a first map in response to an operation triggered for the first map of a target water region, where the client is configured to perform information interaction with the pool robot, and the no-go region includes a region in the target water region, where the pool robot is prohibited from performing a target operation in the region; a first generation module 74 configured to generate a target operation path based on the region information; and a first execution module 76 configured to perform the target operation in another water region along the target operation path, where the another water region is a water region in the target water region other than the no-go region.

In some embodiments, the first execution module includes one of the following: a first moving unit configured to when the no-go region is a target region, and the pool robot is located in the target region, allow the pool robot to move out of the target region and perform the target operation in the another water region along the target operation path; and a first execution unit configured to when the no-go region is the target region, and the pool robot is located outside the target region, perform the target operation in the another water region along the target operation path.

In some embodiments, the first map is generated when the pool robot operates along an edge of the target water region. The first map is a map of the target water region and is a two-dimensional map or a three-dimensional map.

In some embodiments, the region information of the no-go region includes at least one of the following: coordinates of the no-go region displayed on the first map or an identifier of the no-go region displayed on the first map. The identifier includes a name and/or an icon of the no-go region.

In some embodiments, a virtual wall is allowed to be set at any position in the target water region. A plurality of virtual walls is allowed to be set in the target water region.

In some embodiments, when the no-go region is a region defined by a virtual wall, the target operation is performed in the another water region other than the virtual wall.

In some embodiments, the first generation module 74 is configured to generate the target operation path in the following manner: receiving a second map sent by the client, where the second map is generated by the client based on the region information; and generating the target operation path based on the second map; or receiving the region information sent by the client; generating the second map based on the region information; and generating the target operation path based on the second map.

According to still another embodiment of this application, an electronic device is further provided. The electronic device includes a memory, a processor, and a computer program that is stored in the memory and is capable of being run on the processor. When executing the computer program, the processor implements steps of the method in any one of the method embodiments.

It should be noted that each module may be implemented by software or hardware, and for the latter, it may be implemented in the following manner: All modules are located in a same processor, or various modules are located in different processors respectively in a form of any combination. However, this is not limited thereto.

An embodiment of this application further provides a computer-readable storage medium. The computer-readable storage medium stores a computer program. When the computer program is run, steps in any one of the method embodiments are performed.

In some embodiments, the computer-readable storage medium may include, but is not limited to, any medium that can store the computer program, for example, a USB flash drive, a read-only memory (Read-Only Memory, ROM), a random access memory (Random Access Memory, RAM), a removable hard disk, a magnetic disk, or a compact disc.

An embodiment of this application further provides a pool robot. The pool robot includes a memory and a processor. The memory stores a computer program. The processor is configured to: when executing the computer program, perform steps in any one of the method embodiments.

In some embodiments, the pool robot may further include a transmission device and an input/output device. The transmission device is connected to the processor, and the input/output device is connected to the processor.

For details of specific examples in this embodiment, refer to the examples described in the above embodiments and example implementations. Details are not described in this embodiment again.

It is clear that a person skilled in the art should understand that the modules or steps in this application may be implemented by a general-purpose computing apparatus, and the modules may be integrated on a single computing apparatus or distributed on a network including a plurality of computing apparatuses, or may be implemented by program code executed by a computing apparatus. In this way, the program code can be stored in a storage apparatus and executed by the computing apparatus. In addition, in some cases, the shown or described steps may be performed in an order different from the above order, or the modules are respectively manufactured into various integrated circuit modules, or a plurality of modules are manufactured into a single integrated circuit module. In this way, this application is not limited to any particular combination of hardware and software.

The foregoing descriptions are merely optional embodiments of this application, and are not intended to limit this application. For a person skilled in the art, this application may have various modifications and variations. Any modification, equivalent replacement, improvement, or the like made without departing from the principle of this application shall fall within the protection scope of this application.

What is claimed is:

1. A method for controlling a pool robot to operate, applied to a client, wherein the method comprises:
determining a no-go region on a first map in response to an operation triggered for the first map of a target water region, wherein the client is configured to perform information interaction with the pool robot, and the no-go region comprises a region in the target water region, wherein the pool robot is prohibited from performing a target operation in the region; and
transmitting region information of the no-go region to the pool robot to instruct the pool robot to generate a target operation path based on the region information and perform the target operation in another water region along the target operation path, wherein the another water region is a water region in the target water region other than the no-go region.

2. The method according to claim 1, wherein the determining a no-go region on a first map in response to an operation triggered for the first map of a target water region comprises at least one of the following:
receiving an operation instruction and determining the no-go region on the first map in response to the operation instruction, wherein the region information is generated when the no-go region is determined based on the operation instruction; or
determining the no-go region on the first map in response to a touchscreen operation performed on the first map, wherein the touchscreen operation comprises an action performed on the first map to generate the no-go region.

3. The method according to claim 2, wherein the receiving an operation instruction and determining the no-go region on the first map in response to the operation instruction comprises at least one of the following:
determining the no-go region on the first map if a position of the no-go region is input into the client; or
determining the no-go region on the first map if a name of the no-go region is input into the client.

4. The method according to claim 1, wherein the determining a no-go region on a first map in response to an operation triggered for the first map of a target water region comprises at least one of the following:
when the operation is determining a virtual wall on the first map, determining a region defined by the virtual wall as the no-go region; or
when the operation is determining a target region on the first map, determining the target region as the no-go region.

5. The method according to claim 4, wherein the virtual wall is located between a bottom of the target water region and a water surface on the first map.

6. The method according to claim 5, wherein the virtual wall and the target region are allowed to be set at any position in the target water region, wherein a plurality of virtual walls and a plurality of target regions are allowed to be set in the target water region.

7. The method according to claim 5, wherein when the no-go region is determined in real time in a process in which the pool robot performs the target operation in water, and the no-go region is the region defined by the virtual wall, a region away from the pool robot is allowed to be determined as the no-go region.

8. The method according to claim 1, further comprising:
when it is determined that the pool robot is abnormal in a process in which the pool robot performs the target operation in the target water region, determining an abnormal water region in which the pool robot is abnormal; and
setting the abnormal water region as the no-go region on the first map.

9. The method according to claim 8, wherein an abnormality occurred in the process in which the pool robot performs the target operation in the target water region comprises at least one of the following: the pool robot is trapped in a corner in the target water region; the pool robot rolls over in a region in which a step and/or a ladder in the target water region are/is located; or the pool robot is entangled with a device disposed in the target water region.

10. The method according to claim 1, wherein the region information of the no-go region comprises at least one of the following: coordinates of the no-go region displayed on the first map or an identifier of the no-go region displayed on the first map, wherein the identifier comprises a name and/or an icon of the no-go region.

11. The method according to claim 1, wherein the no-go region is determined on the first map before the pool robot performs the target operation, or the no-go region is determined on the first map in real time in a process in which the pool robot performs the target operation in the target water region.

12. A method for controlling a pool robot to operate, applied to the pool robot, wherein the method comprises:
receiving region information of a no-go region transmitted by a client, wherein the client determines the no-go region on a first map in response to an operation triggered for the first map of a target water region, wherein the client is configured to perform information interaction with the pool robot, and the no-go region comprises a region in the target water region, wherein the pool robot is prohibited from performing a target operation in the region;
generating a target operation path based on the region information; and
performing the target operation in another water region along the target operation path, wherein the another water region is a water region in the target water region other than the no-go region.

13. The method according to claim 12, wherein the performing the target operation in another water region along the target operation path comprises at least one of the following:
when the no-go region is a target region, and the pool robot is located in the target region, moving out of the target region and performing the target operation in the another water region along the target operation path; or
when the no-go region is the target region, and the pool robot is located outside the target region, performing the target operation in the another water region along the target operation path.

14. The method according to claim 12, wherein the first map is generated when the pool robot operates along an edge of the target water region, wherein the first map is a map of the target water region and is a two-dimensional map or a three-dimensional map.

15. The method according to claim 12, wherein the region information of the no-go region comprises at least one of the following: coordinates of the no-go region displayed on the first map or an identifier of the no-go region displayed on the first map, wherein the identifier comprises a name and/or an icon of the no-go region.

16. The method according to claim 15, wherein a virtual wall is allowed to be set at any position in the target water region, wherein a plurality of virtual walls is allowed to be set in the target water region.

17. The method according to claim 12, wherein the no-go region is a region defined by a virtual wall.

18. The method according to claim 17, wherein the performing the target operation in another water region comprises at least one of the following:
controlling the pool robot to bypass the virtual wall and perform a cleaning operation on a physical wall in the another water region;
controlling the pool robot to perform the cleaning operation along an edge of the virtual wall in the another water region; or
controlling the pool robot to move along the edge of the virtual wall to the physical wall in the another water region and perform the cleaning operation on the physical wall.

19. The method according to claim 18, wherein the controlling the pool robot to move along the edge of the virtual wall to the physical wall in the another water region and perform the cleaning operation on the physical wall comprises:
controlling the pool robot to move on a bottom of the another water region along the edge of the virtual wall to the physical wall and perform the cleaning operation on the physical wall.

20. The method according to claim 17, wherein the performing the target operation in another water region comprises at least one of the following:
after the pool robot is controlled to perform a cleaning operation on a first physical wall in the another water region, controlling the pool robot to move to a second physical wall in the another water region along an edge of the virtual wall and perform the cleaning operation on the second physical wall; or
after the pool robot is controlled to perform the cleaning operation on a physical wall in the another water region, controlling the pool robot to perform the cleaning operation on a bottom of the another water region.
